(19) United States
(12) Patent Application Publication
(10) Pub. No.: US 2006/0219811 A1
(43) Pub. Date: Oct. 5, 2006

(54) Fan actuator

(75) Inventor: John R. Woods, Woodland Hills, CA (US)

Correspondence Address: PILLSBURY WINTHROP SHAW PITTMAN LLP, P.O BOX 10500, McLean, VA, 22102, US

(73) Assignee: Spraytex, Inc., Valencia, CA (US)

(21) Appl. No.: 11/369,302

(22) Filed: Mar. 7, 2006

Related U.S. Application Data
(60) Provisional application No. 60/662,661, filed on Mar. 17, 2005.

(51) Int. Cl. B05B 3/02

(52) U.S. Cl. 239/222.11; 239/337; 239/222.17

(57) ABSTRACT

A fan including blades for an actuator generally used with a pressurized aerosol spray can or air compressor sprayer that delivers surface texture materials to be sprayed onto a drywall or other supporting surface. The fan may be positioned inside or outside of the actuator orifice to create various patterns or textures of the sprayed product. The fan may come with an insert that is removably attachable to the actuator so that the same actuator may be used with different fans.

### RELATED APPLICATIONS

This application claims the benefit of U.S. Provisional Application No. 60/662,661 titled “FAN ACTUATOR,” filed Mar. 17, 2005, which is herein incorporated by reference in its entirety.

### BACKGROUND OF THE INVENTION

1. Field of Invention

Embodiments of the present invention relate generally to an actuator for use with a pressurized aerosol spray can or air compressor sprayer that delivers surface texture materials, including a water-based pressurized substance in liquid or semi-liquid form that is storable and dispensable from an air-tight pressurized container, to be sprayed onto a drywall or other supporting surface. More particularly, embodiments of the present invention relate to an actuator, with a fan with blades positioned inside, that can create various patterns or textures of the sprayed product.

2. Description of Related Art

Aerosol spray cans and air compressor sprayers are generally used to atomize a pressurized liquid into a spray which can be delivered into a room or to coat an object with the atomized spray. The atomized spray is facilitated through the spray tip, or actuator in aerosols. A traditional actuator can be used to spray different materials. However, the practice of dispensing materials through traditional actuators generally yields only one pattern that generally does not differ significantly from one another.

In order to achieve different sprayed patterns or textures, the aerosol industry has devised different surface texture materials and procedures used to create different desired patterns or textures. This generally requires obtaining specific surface texture materials for the desired texture, and different tools with which to apply the materials, in order to complete just one texture. Traditional procedures to create desired patterns also involve other complications. For example, in repairing stucco-covered surfaces, it is difficult to recreate the same stucco effect in the repaired areas. The conventional practice involves removing the damaged portions of the surface and filling in any holes, depressions, or the like with a prepared patch material. The patch material is applied by means of a trowel or other manipulating tool that will patch the hole or depression and prepare the surface area to receive a finish surface coating. After the patch material is cured and adhered to the original support material, the final coating is applied to the smoothed surface. However, this process leaves a smooth surface that is not matched to the surrounding stucco texture. Consequently, to obtain the desired stucco texture, a specialized composition needs to be applied as the final coating.

There are some aerosol compositions known in the art for producing a surface having an abrasive grit that can be dispensed from a suitable aerosol container. Such compositions generally comprise a liquid propellant, an abrasive grit and a binder solution that can affix the abrasive grit onto the surface. However, because the abrasive grit can only be sprayed on in only one manner, and cannot be customized in any way, it does not provide the same surface texture to that of stucco. Consequently, the difference between the particulate sizes can still be distinguished. Furthermore, in contrast to the traditional stucco composition, the ingredients of compositions of this type, and the steps taken to use it, render the product and resulting method more costly and complicated.

Therefore, there exists a long-standing need to provide an actuator or spray tip that may be used to readily disperse material from a container in aerosol form in a variety of patterns or textures.

### BRIEF SUMMARY

In accordance with an embodiment of the invention, a fan has been developed for use in association with the actuator or spray tip of aerosol spray cans or air compressor sprayers. An embodiment of the present invention provides an actuator including a fan inside the actuator that can be used to spray the material in the container in a wide variety of patterns and textures, without involving multiple surface texture materials or complicated and costly procedures. The actuator may be compatible for use with any generic aerosol spray can.

The actuator according to an embodiment of the invention is equipped with a fan with blades inside the actuator. The fan may sit inside the orifice of the actuator where the sprayed product exits. When the actuator is engaged, the pressure forces out the material contained in the aerosol spray can and the released material hits the blades so that the blades spin. The sprayed material passes through the spinning blades as it is being expelled. As a result, a spray pattern is created that is different from the pattern that would have been created with a traditional actuator. The fan blades change the spray atomization to create a different surface effect.

In another embodiment of the invention, the fan may be positioned outside of the actuator. This exterior fan operates similarly to the fan that is inside the actuator. When the actuator is engaged, the pressure releases the material from the aerosol container which spins the fan blades as the sprayed product is expelled. The resulting pattern and texture may differ from that created by the interior fan due to the change in distance that the sprayed product must travel before it is dispersed by the blades.

The fan blades may have various embodiments. By changing the number of the blades, the spray pattern and texture will change accordingly. In one embodiment, a six-blade fan may be used. In another embodiment, the fan may include a 4-blade configuration. In yet another alternative, the fan may include a 3-blade configuration. Furthermore, the fan blades may also vary in their shape and size. In one embodiment of the invention, the fan may comprise blades that are linear and thin. In an alternative, the fan may comprise wide blades that are curved and angular, with larger surface area.

In yet another embodiment, an insert may be provided that can be introduced or removed from the actuator orifice. The insert may include an opening, with a fan inside or outside of the insert opening. Depending on what pattern or texture is desired, the user may select a specific insert with the accommodating fan and introduce the insert into the actuator. This interchangeability allows the user to create entire array of spray patterns and textures, with one air compressor sprayer or aerosol spray can, that may fit the use of many different products. Additionally, the insert makes possible the use of one surface texture material to give different patterns and textures merely by changing the insert and fan to be used. Depending on the desired pattern or texture, the fan and insert may be composed of various materials, flexible or rigid.

### BRIEF DESCRIPTION OF THE DRAWINGS

A detailed description of embodiments of the invention will be made with reference to the accompanying drawings, wherein like numerals designate corresponding parts in the figures.

FIG. 1 is a cross-sectional view of an actuator assembly with a fan in disassembled form according to an embodiment of the invention.

FIG. 2 is a perspective view of an actuator assembly with an interior fan according to an embodiment of the invention.

FIG. 3 is a perspective view of an actuator assembly with an exterior fan according to an embodiment of the invention.

FIG. 4 is a cross-sectional view of an actuator assembly with a fan in an insert in disassembled form according to an embodiment of the invention.

FIG. 5 is a perspective view of an actuator assembly with a fan in an insert according to an embodiment of the invention.

FIG. 6 is a perspective view of an actuator assembly with an insert including an exterior fan according to an embodiment of the invention.

FIG. 7 is a front-view of a fan with six blades according to an embodiment of the invention.

FIG. 8 is a front-view of a fan with four blades according to an embodiment of the invention.

FIG. 9 is a front-view of a fan with three blades according to an embodiment of the invention.

### DETAILED DESCRIPTION

In the following description, reference is made to the accompanying drawings which form a part hereof and which illustrate several embodiments of the present invention. It is understood that other embodiments may be utilized and structural and operational changes may be made without departure from the scope of the present invention.

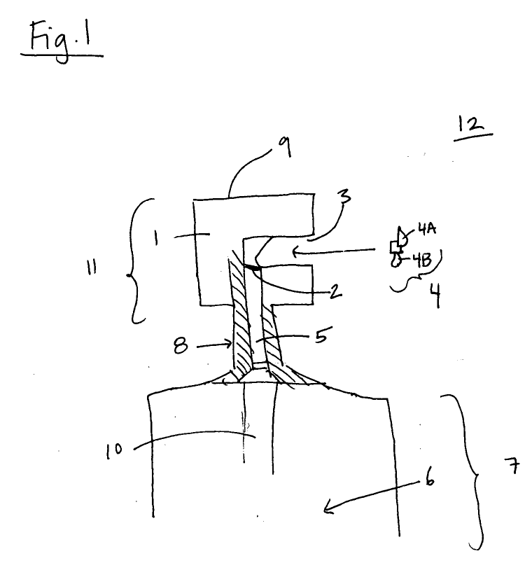

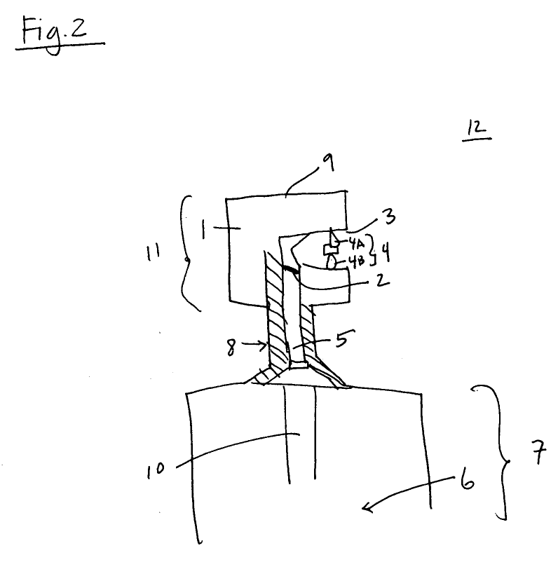

As shown in FIG. 1 and FIG. 2, an actuator according to an embodiment of the invention, is illustrated schematically by the reference numeral 11, for an aerosol spray can 7. FIG. 1 shows the actuator 11 in a disassembled form. FIG. 2 shows the actuator 11 an assembled form. The actuator comprises a body 1 that includes an inlet 2, a fan 4 that fits into the orifice 3 of the inlet 2, and a main valve 5 that leads down into the cavity 6 of the can 7. The actuator body 1 is mounted on a neck 8 that contains the main valve 5 that leads down into the cavity 6 of the can 7. The top of the actuator body 1 forms a button tip 9 on which the user may push down upon to engage the actuator 11 and deliver an aerosol spray as any conventional aerosol spray containers known in the art. The lower part of the main valve 5 extends into a lower valve 10. Once the actuator assembly 12 is engaged, the inlet 2 opens, and the main valve 5 and the lower valve 10 maintain fluid communication to dispense the fluid from the cavity 6 up through the inlet 2 and exiting from the orifice 3, as with other aerosol spray cans known in the art. In an alternative embodiment, the container may include a propellant, such as compressed air or liquid gas, to further facilitate the force of expulsion and blast velocity with which the aerosol spray is released.

The button tip 9 provides an area for a user to apply pressure to the actuator 11 in order to open the main valve 5 to which the actuator 11 is connected. By opening the main valve 5 the pressurized contents of the cavity 6 are released up through the main valve 5 and into the inlet 2 where it is delivered out.

As seen in FIGS. 1 and 2, the fan 4 is placed in the orifice 3 of the inlet 2 so that the sprayed product passes through the fan 4 when the sprayed product exits. When the actuator 11 is engaged, the pressure from the aerosol container 7 releases the contents which hit the blades 4A and 4B so that the blades 4A and 4B spin. The sprayed material passes through the spinning blades 4A and 4B during the expulsion. As a result, a spray pattern is created that is different from the pattern that would have been created in a traditional actuator, without the fan 4. The fan blades 4A and 4B change the spray atomization released by the aerosol can to create a different effect.

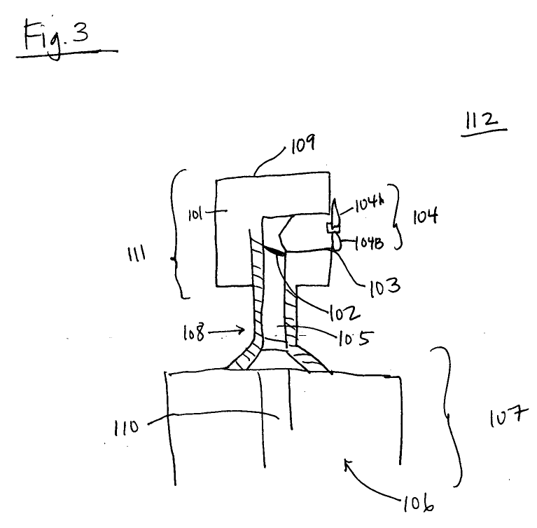

In FIG. 3, an embodiment of the invention is shown wherein the actuator assembly 112 includes a fan 104 that is placed on the exterior of the actuator 111. The fan 104 is positioned immediately outside of the orifice 103 of the inlet 102. When the actuator 111 is engaged, the pressure releases the contents from the aerosol container 107 which spins the fan blades 104A and 104B as the sprayed product is expelled. While the fan 104 in this embodiment operates similarly to that of the previous embodiment, it can yield a resulting pattern and texture that differs from that created by the interior fan 4 (as shown in FIGS. 1-2) due to the change in distance that the sprayed product must travel before it is dispersed by the blades.

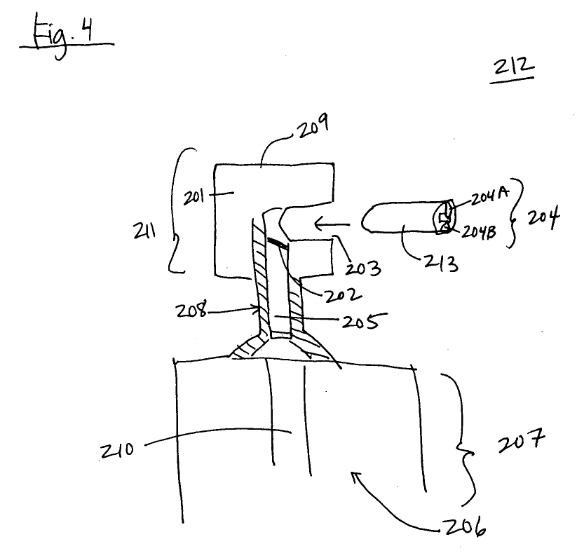

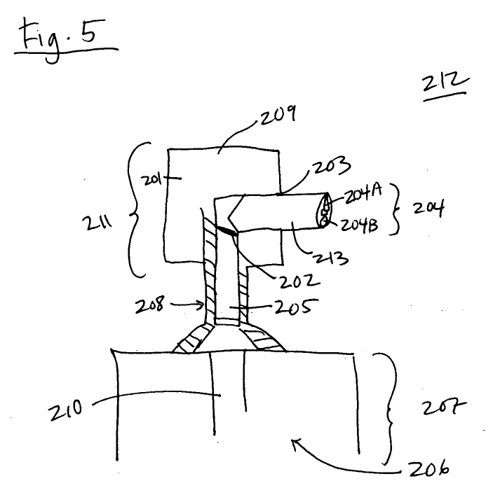

FIGS. 4-6 illustrate another embodiment of the invention wherein the actuator assembly 212 further includes an insert 213 in the orifice 203 of the inlet 202. The insert may be permanently fixed in the orifice or the insert may be removably attached to the orifice. In such a case, the insert may be removed from the actuator and interchanged with another insert with a different fan. This allows the user to create a variety of patterns or textures without having to purchase an entire new aerosol spray can or surface texture material. The insert 213 may fit in the orifice 203 in a way that part of the insert 213 protrudes from the orifice 203 once the insert 213 is fully placed in the inlet 202. In another embodiment, the insert may also fit in the orifice so that the insert is flush with the actuator body (not shown). As shown in FIG. 4 and FIG. 5, the insert 213 may further include a fan 204 that is positioned within the insert 213. Like the previous embodiments, once the actuator 211 is engaged, and the inlet 202 is opened, the pressure releases the contents from the container 207 and spins the fan blades 204A and 204B as the sprayed product is expelled. This may create yet another texture and pattern that is distinct from those created by the other embodiments.

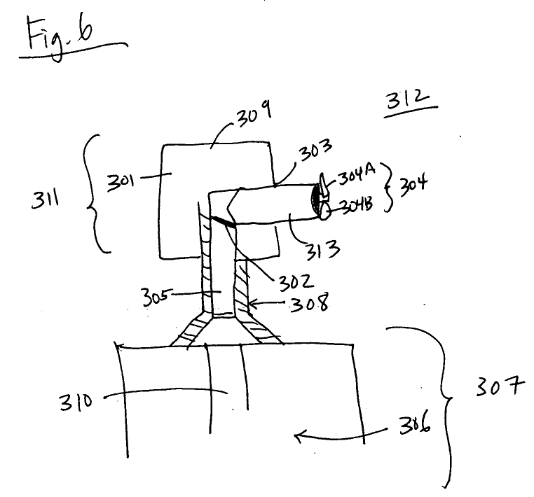

In FIG. 6, an alternative embodiment is shown of the actuator assembly 312 wherein the actuator 311 includes an insert 313 with a fan 304 on the exterior of the insert 313. As with the other embodiments, the top of the actuator body 301 forms a button tip 309 on which the user may push down upon to engage the actuator 311 and deliver an aerosol spray. Once the actuator assembly 312 is engaged, and the inlet 302 opens, the main valve 305 and the lower valve 310 maintain fluid communication to dispense the fluid from the cavity 306 up to the inlet 302 and through the insert 313. Due to the difference in distance that the sprayed product must travel to contact the fan blades 304A and 304B and the difference in position of the fan 304, a different texture and pattern is again created.

Without being limited, several other embodiments of the actuator fan comprising different blades, and the corresponding actuators and inserts, are described below.

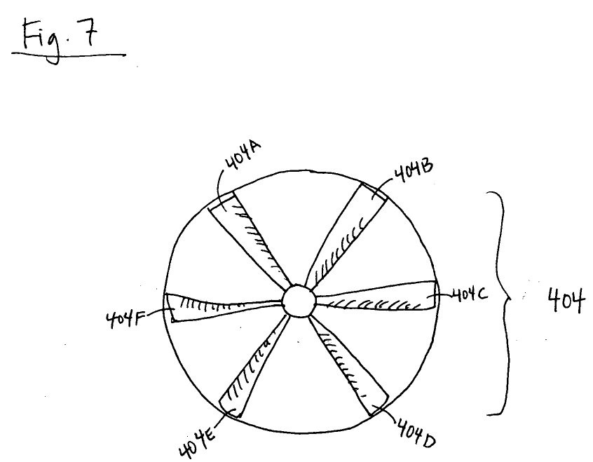

As shown in FIG. 7, one embodiment of the fan 404 includes six blades 404B, 404C, 404D, 404E, and 404F. The blades 404A, 404B, 404C, 404D, 404E and 404F may be linear and thin in configuration.

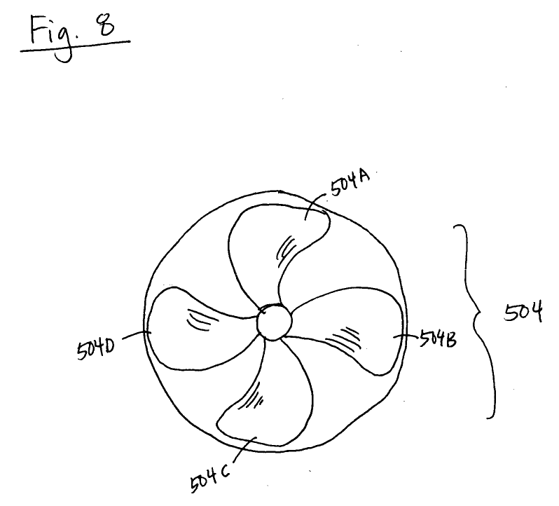

As shown in FIG. 8, one embodiment of the fan 504 includes four blades 504B, 504C and 504D. The blades 504A, 504B, 504C and 504D may be curved and angular in configuration, with larger surface area.

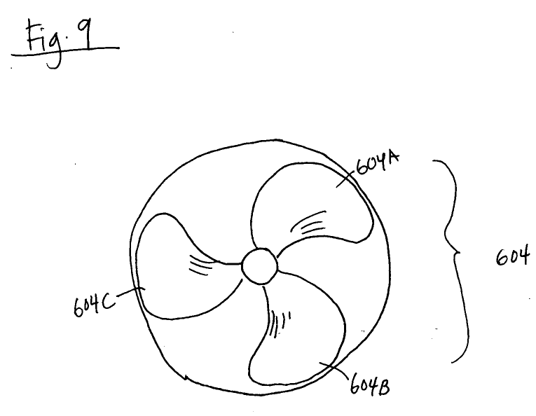

As shown in FIG. 9, another embodiment of the fan 604 may include three blades 604A, 604B and 604C. The fan 604 is illustrated with blades 604A, 604B and 604C that are curved and angular, with larger surface area.

As demonstrated in the previous embodiments, the fan blades may have various embodiments. Each of the three previously described embodiments can be configured so that the fan may embody any combination of blade number, shape, and size. By changing the number and type of the blades, the spray pattern and texture will change accordingly. Depending on the desired pattern or texture, the fan and insert may also be composed of various materials, flexible or rigid. For example, metals, silicon, plastics, and rubber, are a few materials that may be used.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. An actuator assembly for an aerosol container comprising:
an actuator body;
an orifice formed in the actuator body, wherein the orifice defines an inlet;
a main valve and a lower valve operatively located between the sprayable material and the inlet, the valves being in fluid communication with one another and adapted to open and close communication between the sprayable material and the inlet; and
a fan configured to fit into the orifice, wherein the fan further includes one or more blades adapted to spin when the sprayable material exits through the orifice.

2. The actuator assembly according to claim 1, wherein the fan sits within an insert, the insert being removably attached to the orifice.

3. The actuator assembly according to claim 1, wherein the fan extends from the orifice.

4. The actuator assembly according to claim 1, wherein the fan fits entirely within the orifice.

5. The actuator assembly according to claim 1, wherein the fan includes three blades.

6. The actuator assembly according to claim 1, wherein the fan includes four blades.

7. The actuator assembly according to claim 1, wherein the fan includes five blades.

8. The actuator assembly according to claim 1, wherein the one or more blades is of a linear and thin shape.

9. The actuator assembly according to claim 1, wherein the one or more blades is of an angular and wide shape.

10. The actuator assembly according to claim 1, wherein the fan is formed from a material selected from the group consisting of silicone, rubber, soft plastic and mixtures thereof.

11. The actuator assembly according to claim 1, wherein the fan is formed from a material selected from the group consisting of metal, fiberglass, polycarbonate and mixtures thereof.

12. An aerosol system comprising a container, a sprayable material and an actuator assembly that sprays the sprayable material from the container, wherein the actuator assembly comprises:
an actuator body;
a button tip disposed on the actuator body;
an orifice formed in the actuator body, wherein the orifice defines an inlet;
a main valve and a lower valve operatively located between the sprayable material and the inlet, the valves being in fluid communication with one another and adapted to open and close communication between the sprayable material and the inlet; and
a fan configured to fit into the orifice, wherein the fan further includes one or more blades adapted to spin when the sprayable material exits through the orifice.

13. The aerosol system according to claim 12, wherein the sprayable material comprises a propellant.

14. The aerosol system according to claim 12, wherein the fan sits within an insert, the insert being removably attached to the orifice.

15. The aerosol system according to claim 12, wherein the fan fits entirely within the orifice.

16. The aerosol system according to claim 12, wherein the fan extends from the orifice.

17. The aerosol system according to claim 12, wherein the fan includes three blades.

18. The aerosol system according to claim 12, wherein the fan includes four blades.

19. The aerosol system according to claim 12, wherein the fan includes five blades.

20. The aerosol system according to claim 12, wherein the one or more blades is of a linear and thin shape.

21. The aerosol system according to claim 12, wherein the one or more blades is of an angular and wide shape.

22. The aerosol system according to claim 12, wherein the fan is formed from a material selected from the group consisting of silicone, rubber, soft plastic and mixtures thereof.

23. The aerosol system according to claim 12, wherein the fan is formed from a material selected from the group consisting of metal, fiberglass, polycarbonate and mixtures thereof.
